(19) United States
(12) Patent Application Publication
(10) Pub. No.: US 2003/0047198 A1
(43) Pub. Date: Mar. 13, 2003

(54) Apparatus for washing bottles

(76) Inventor: Mario C. Fargnoli, Morristown, NJ (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/172,948

(22) Filed: Jun. 17, 2002

Related U.S. Application Data
(60) Provisional application No. 60/318,669, filed on Sep. 12, 2001.

(51) Int. Cl. B08B 9/34

(52) U.S. Cl. 134/22.18; 134/171

(57) ABSTRACT

The invention is a device used for washing bottles for reuse in bottling wine, beer, soda or other liquids, which is comprised of a supporting frame, an input for water from a water source, a number of water spouts or rinse attachments over which bottles can be inverted for washing, and a manifold for channeling the water into the water spouts or rinse attachments. The device may be fashioned from a variety of materials, including metals and plastics. The preferred construction has six water spouts or rinse attachments, which clean the bottles automatically after the bottles are placed over them, and is made from standard pipes and fittings. The bottles drain automatically as they are cleaned. The device requires minimal operator attention and can be set up, started and left unattended until completion of the operation. A particular embodiment of the apparatus incorporates a fan spray nozzle providing a fan spray angle of 110 degrees. The device functions optimally at a water flow rate of 0.8 to 1.0 gallons per minute.

### CROSS-REFERENCES TO RELATED APPLICATIONS

This application claims the priority date of Provisional Application No. 60/318,669, filed Sep. 12, 2001, entitled “Apparatus for Washing Bottles”.

### FEDERALLY SPONSORED RESEARCH

Not Applicable SEQUENCE LISTING, TABLE OR COMPUTER PROGRAM

Not Applicable

### BACKGROUND OF THE INVENTION

1. Field of Invention

This invention pertains to the bottling industry, both commercial and hobbyist, wherein bottles are initially cleaned or reused for bottling wine, beer, soft drinks and other liquids.

### PRIOR ART

Bottle washing devices are known in industry and range from commercial high-volume bottle washers to single bottlebrushes and other techniques. Low volume bottle washers also exist, but typically serve to wash a fairly large number of bottles at a time. They are also quite expensive, often being made from low-run machined parts.

Single bottle washing devices typically require constant user input to complete the operation and cannot be left to clean the bottle without constant attention. In some methods of washing, the bottle must be held against a trigger to enable the flow of water or other cleaning liquid. This requires the constant attention of the operator.

U.S. Pat. No. 5,564,448 to Lincoln teaches an elongated liquid supply pipe, including a plurality of angled fittings connected along a pipe. Each fitting includes a fan spray nozzle. This system is used in a washing system for containers, particularly beverage cans on a conveyor belt. Disposed above the cans is a fan spray device, which is used to spray water into the open can from above. The spray nozzle in the Lincoln patent operates at an angle of 90 degrees between the spray and the direction of the pipe that the spray nozzle is on. The fan spray in such a configuration would exit only one side of the spray arm and, if used in the interior of a bottle, would spray onto only a small portion of the interior surface of the bottle.

U.S. Pat. No. 5,855,219 to Spencer teaches a device for cleaning baby bottles, which attaches to a kitchen faucet, and which has a plurality of small orifices in two sheathes, one of which rotates, thus sending the spray out at varying angles. This device is placed inside the bottle that is the subject of cleaning. This device is very complicated in having moving components, and thus would be quite costly.

### OBJECTS AND ADVANTAGES

It is an object of the present invention to provide an apparatus for washing bottles that can be set up, started and left unattended until completion of the operation. It can be readily disassembled for storage. It has an additional advantage that several bottles can be washed at a time.

It is a further object of the present invention to provide a bottle washing device that cleans bottles effectively due to the fan pattern of the spray used, with the only effort required being the placement of the bottle over the washing nozzle.

The advantages of the present invention are that it is suitable for small quantity bottlers, such as home brewers and winemakers, yet it allows more than the typical one bottle to be cleaned at a time. Additionally, the present invention can be constructed of readily available standard components, and thus can be made at low cost. Having no moving components, wear-out, and the subsequent need for replacement, is avoided.

By reviewing and considering the drawings and descriptions further objects and advantages of the instant invention will be apparent.

### BRIEF SUMMARY OF THE INVENTION

The present invention is a device for washing bottles comprised of a supporting frame, an input for water from a water source, a plurality of water spouts over which bottles can be inverted for washing, and a manifold for channeling the water into said plurality of water spouts. Bottles are placed over the spouts, water is turned on and the pressure of the water cleans the bottle without further operator attention until removal. A further embodiment of this invention incorporates a fan-shaped spray of a specific angular dimension, which leads to effective cleaning of the bottle.

### BRIEF DESCRIPTION OF THE DRAWING

In the drawing which illustrates the embodiments presently contemplated for carrying out the present invention:

FIG. 1 depicts the bottle washing apparatus as fully constructed and ready for use.

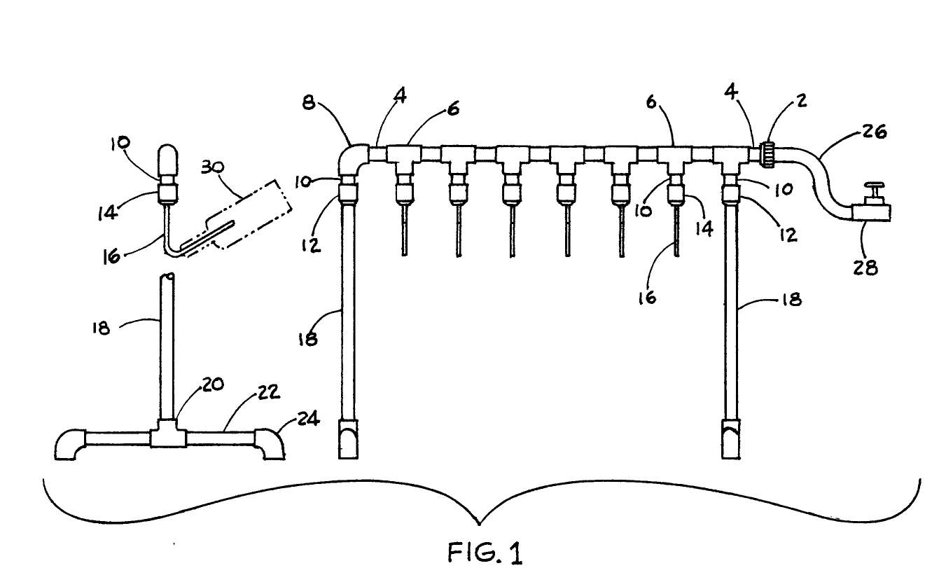

FIG. 2 depicts the bottle washer as equipped with the fan spray nozzle.

FIG. 3 shows the bottle placed over the fan spray head and the pattern of the fan spray.

### DETAILED DESCRIPTION OF THE INVENTION

An embodiment of the invention is comprised of a water source 28, a garden hose 26 connecting the water source to the apparatus, and the apparatus itself. The hose 26 is connected to a female hose to female iron pipe swivel adapter fitting 2. This swivel fitting is then connected to a manifold constructed of alternating brass pipe nipples 4 and brass pipe tees 6, such that the manifold begins and ends with a brass pipe nipple 4. At the far end of the manifold from the garden hose, there is located a brass elbow fitting 8, joined to the brass pipe nipple 4. At each end of the manifold, connected in the first instance to the brass pipe tee 6 at the garden hose end and in the second instance to the brass elbow fitting 8 at the other end, there is a leg supporting the structure. Each leg is constructed from a brass pipe nipple 10, a brass swing check valve 12, a black iron pipe 18, a black iron pipe tee fitting 20, to which fitting 20 there are connected two lengths of black iron pipe 22, and at the end of each pipe 22 there is located a black elbow fitting 24 completing the leg stand.

Extending downward off the remaining brass pipe tees 6, there is a brass pipe nipple 10, which is connected to a male hose to female iron pipe adapter 14, which is itself connected to a Jet™ bottle washer (Jet™ Carboy and Bottle Washer Co., Traverse City, Mich.) rinse attachment 16.

The number of stations of the manifold which lead to a washing attachment is selected based on the needs of the operator and the water pressure available. While as few as one station could be used or as many as the number that can be supported by the water pressure and flow available, the preferred embodiment utilizes six such stations.

The Jet™ bottle rinse attachments 16 are oriented in such a fashion that the outlet portion of the tube is pointing generally upward at about a 45 degree angle. An operator places one empty bottle 30 over each Jet™ bottle rinse attachment 16, inserting the tube of the Jet™ bottle rinse attachment 16 into the neck of the bottle 30. Placing the bottle on the Jet™ bottle rinse attachment activates its trigger allowing water flow. The hose 26 is connected to the apparatus and to the water source 28, and the supply of water is turned on. Washing can take place for as long a period as is desired. Upon completion of the washing cycle, the bottles 30 are removed deactivating the trigger mechanism of the Jet™ bottle rinse attachment. The cleaned bottles 30 may then be removed and reused.

The check valve 12 serves to prevent water from escaping down through the legs of the stand and may be replaced by any similar means for blocking the flow of water. By utilizing black iron pipe in the construction of the apparatus, it has a suitable weight that makes the apparatus quite stable and the cost is low.

In an additional embodiment, the various lengths of pipe and the associated fittings may be replaced in part by plastic piping and plastic fittings including, but not limited to, standard plumbing polyvinyl chloride piping.

This additional embodiment would function in the same fashion as the preferred embodiment but would be of lighter construction. It would be well suited to a permanent installation, if one were desired.

In yet another embodiment, the manifold section may be formed from a single piece of machined material made from stainless or treated steel, plastic, copper, brass or similar, which would replace the brass pipe nipples 4 and brass pipe tees 6.

Functionally this embodiment operates in the same fashion as the preferred embodiment, but with fewer discrete components. This embodiment may lend itself to lower cost in higher volume manufacture. By reducing components, cost may be reduced if a suitable number of units can be produced to take advantage of economy of scale.

In a further embodiment, the manifold and the outlet components may be fashioned by welding, braising or soldering of tubing materials of stainless steel, copper or brass, thus replacing the brass pipe nipple 10, the female iron pipe adapter 14, and the Jet™ bottle rinse attachment 16, forming a continuous tube with outlet branches.

This embodiment functions in a similar fashion to those above, but may be useful and simple, by using welded, braised, or soldered construction, in small to moderate production volume applications.

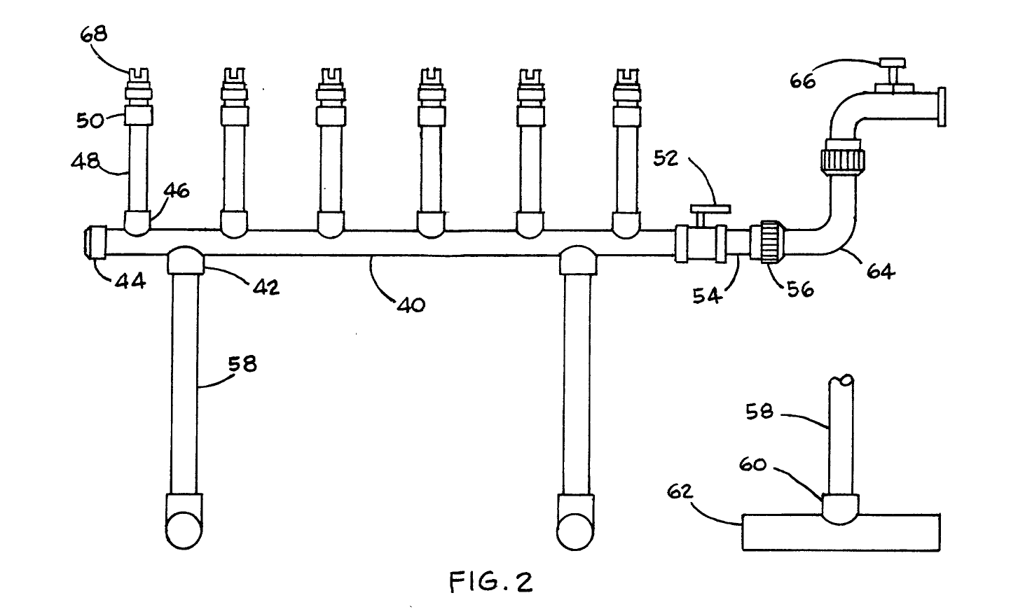

Another embodiment of the present invention utilizes a different means of providing water to clean the inside of the bottle. In this embodiment, which is shown in FIG. 2, a fan spray nozzle is used instead of the Jet™ bottle washer device. This fan spray nozzle is of a type similar to that available from Lurmark limited, Longstanton, Cambridge, CB4 5D5, England, under their Hypro™ name. Additionally, this fan spray head is disposed upright and the bottle is placed over it.

In this embodiment, shown in FIG. 2, a bottle washing apparatus similar to that in the previous discussion is made from various fittings that are either welded or attached by their threads.

First, there is a manifold, constructed from a male pipe 40, to which are welded female threaded couplings 42. A support stand is made from male threaded pipe legs 58, which are individually threaded into the female threaded couplings 42 at one end and are threaded into a base at the other, which base is made from a female coupling 60 welded to a pipe 62.

The remainder of the manifold is comprised of six female threaded couplings 46 welded to the male pipe 40. At one end of the metal pipe 40 is an end cap 44. The other threaded end of the male pipe connects to a shut-off valve 52, which in turn is connected to male coupling 54, which is further connected to female hose swivel to coupling adapter 56. A garden hose 64 is attached to the female hose swivel to coupling adapter 56 at one end and connected at the other to a water source 66.

Attached to female threaded coupling 46 are a male threaded nipple 48, which functions as a supporting extension, and a female threaded coupling 50. A spray nozzle 68, which generates a fan-shaped spray, is threaded into female threaded coupling 50.

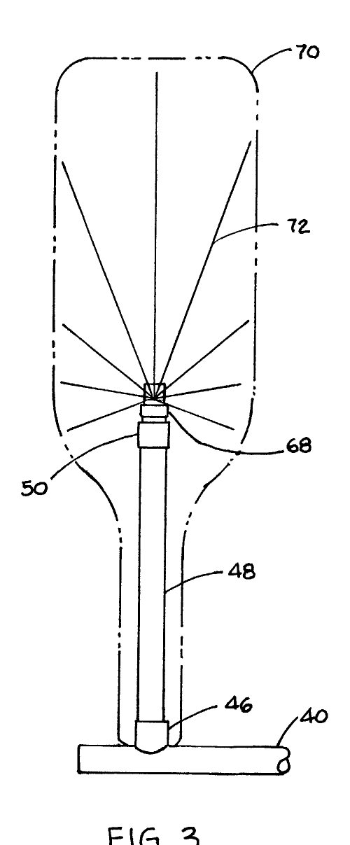

FIG. 3 shows a bottle 70 placed over the fan spray nozzle 68 and the pattern of the fan spray 72. The spray nozzle 68 produces a fan spray 72 in a pattern of a specific angle, thus providing effective cleaning of the bottle. The length of the male threaded nipple 48 is selected by length to achieve an appropriate position of the spray within the bottle 70, based on the bottle size.

It has been determined that there is an optimal spray angle of the water 72 that exits the spray nozzle 68. A range of angles including the fixed angles of 25, 40, 65, 90 and 110 degrees was tested. Optimal cleaning was achieved with the 110 degree fan spray. All other spray angles were inadequate in producing a cleaning action, with 90 degrees being marginal.

Additionally, water flow rate was found to be important. Flow rates over a range of 0.2 to 1.0 gallons per minute were tested. A flow rate of between 0.8 and 1.0 gallons per minute was found to be optimal. All flow rates below 0.8 gallons per minute were inadequate.

### CONCLUSIONS, RAMIFICATIONS, AND SCOPE

Previously used bottles are often utilized in bottling wine, beer, soda and other liquids in low volume applications, particularly as made in the home, but also in commercial low volume production runs. The instant invention serves to fill a need for a device that will clean several bottles at a time for initial cleaning or reuse, yet is simple enough to be constructed at a low cost. The device in its preferred embodiment cleans six bottles at a time and is fed with water through a garden hose. The components are readily available and the entire construction can be made for a reasonably low cost, suitable for limited production runs.

Although the above description provides specific details and examples of the preferred embodiments of the invention, it should not be construed to limit the scope of the invention.

The scope of the invention should be determined from the claims below and their legal equivalents, rather than from the specific examples and details given.

I claim:

1. An apparatus for washing bottles comprised of a supporting frame, an input for water flow from a water source, a plurality of water rinse attachments over which bottles can be inverted for washing, and a manifold for channeling the water into said plurality of water spouts.

2. The apparatus for washing bottles of claim 1, further characterized in that it is assembled from an appropriate selection of pipes and fittings.

3. The apparatus for washing bottles of claim 1, wherein the number of water spouts is six.

4. The apparatus for washing bottles of claim 1, wherein the manifold is fashioned from a single piece of metal.

5. The apparatus for washing bottles of claim 1, wherein the manifold is fashioned from a single piece of plastic.

6. The apparatus for washing bottles of claim 1, wherein the manifold and spouts are welded together from tubing.

7. The apparatus for washing bottles of claim 1, wherein the manifold and spouts are braised together from tubing.

8. The apparatus for washing bottles of claim 1, wherein the manifold and spouts are soldered together from tubing.

9. The apparatus for washing bottles of claim 2, wherein the pipes and fittings are made from a metal selected from the group consisting of brass, copper, stainless steel and iron.

10. The apparatus for washing bottles of claim 2, wherein the pipes and fittings are made of plastic.

11. The apparatus of claim 6, wherein the tubing is made from a metal selected from the group consisting of brass, copper and stainless steel.

12. The apparatus of claim 10, wherein the plastic is polyvinyl chloride.

13. The apparatus of claim 1, wherein said water rinse attachment comprises a fan spray nozzle means.

14. The apparatus of claim 13, wherein said fan spray nozzle means is attached to a supporting extension.

15. The apparatus of claim 13, further characterized by said fan spray nozzle means producing a fan spray angle of at least 110 degrees.

16. The apparatus of claim 13, further characterized by said water flow having a rate of 0.8 to 1.0 gallons per minute.

17. A method for washing bottles comprising the steps of
a) providing a plurality of water rinse attachments over which bottles can be inverted for washing,
b) attaching said plurality of water rinse attachments to a manifold means for channeling the water into said plurality of water rinse attachments,
c) supporting said manifold means with a support frame,
d) providing a water source, and
e) providing a connecting means for attaching said manifold to said water source.
